(19) United States
(12) Patent Application Publication
(10) Pub. No.: US 2014/0292469 A1
(43) Pub. Date: Oct. 2, 2014

(54) POWER INDUCTOR AND MANUFACTURING METHOD THEREOF

(71) Applicant: SAMSUNG ELECTRO-MECHANICS CO., LTD., Suwon (KR)

(72) Inventors: Hye Yeon CHA, Yongin (KR); Hwan Soo LEE, Suwon (KR); Moon Soo PARK, Suwon (KR); Young Do KWEON, Suwon (KR)

(73) Assignee: SAMSUNG ELECTRO-MECHANICS CO., LTD., Suwon (KR)

(21) Appl. No.: 14/164,640

(22) Filed: Jan. 27, 2014

(30) Foreign Application Priority Data
Mar. 26, 2013 (KR) 10-2013-0032211

(51) Int. Cl. H01F 27/28

(52) U.S. Cl. CPC H01F 27/2804
USPC 336/200; 205/122

(57) ABSTRACT

Disclosed herein is a power inductor including: an opening part penetrating through the insulating layer; an upper coil electrode pattern formed on an upper surface of the insulating layer and having a form in which it is wound around the opening part; a lower coil electrode pattern formed on a lower surface of the insulating layer and having a form in which it is wound around the opening part; and metal layers plated on a surface of the innermost pattern of the upper coil electrode pattern and a surface of the innermost pattern of the lower coil electrode pattern, wherein the metal layers plated on the surfaces of the innermost patterns of the upper and lower coil electrode patterns are extended to an inner wall of the opening part to thereby be connected to each other.

### CROSS REFERENCE(S) TO RELATED APPLICATIONS

This application claims the benefit under 35 U.S.C. Section 119 of Korean Patent Application Serial No. 10-2013-0032211, entitled “Power Inductor and Manufacturing Method Thereof” filed on Mar. 26, 2013, which is hereby incorporated by reference in its entirety into this application.

### BACKGROUND OF THE INVENTION

1. Technical Field

The present invention relates to a power inductor and a manufacturing method thereof, and more particularly, to an interlayer connection structure of coil electrode patterns included in a power inductor.

2. Description of the Related Art

In accordance with the development of information technology (IT), an apparatus has been rapidly miniaturized and thinned. Therefore, the demand of a market for a small and thin device has increased. Therefore, in a power inductor which is a kind of surface mounted device (SMD), products having a thin film type structure have been developed.

FIG. 1 is a cross-sectional view of a general thin film type power inductor.

Referring to FIG. 1, the general thin film type power inductor 1 has a structure in which a coil electrode pattern 2 having a coil shape is enclosed by an insulator 3 and the vicinity thereof is filled with a metal-polymer composite 4 to make a flow of a magnetic flux smooth.

The coil electrode patterns 2 are connected to external electrodes 5. More specifically, a plurality of coil electrode patterns 2 have a structure in which they are stacked, having a predetermined interval therebetween, and interlayer connection thereof are made by via electrodes 6.

A manufacturing process of an inductor device according to the related art having the above-mentioned configuration will be described with reference to Korean Patent Laid-Open Publication No. 1999-0066108. First, via electrodes for interlayer connection of coil electrode patterns plated on upper and lower surfaces of an insulating layer should be formed. To this end, an operation of processing a via-hole at a predetermined position of the insulating layer should be performed.

Then, an operation of forming a via electrode in the processed opening part by filling and plating is performed. Here, as a pre-processing process of the filling and plating, a process of depositing a seed layer (not shown) on a surface of the insulating layer including an inner wall of the opening part should be performed.

After the via electrode is completed through the above-mentioned process, a subsequent process is performed to sequentially form coil electrode patterns, an insulator, a metal-polymer composite, and the like, thereby finally completing an inductor device.

As described above, in the manufacturing method of an inductor according to the related art, since the via electrode for interlayer connection of the coil electrode patterns should be necessarily formed before the coil electrode patterns are plated, a process becomes complicated, such that a process cost and a process time cannot but be increased.

### RELATED ART DOCUMENT

### Patent Document

(Patent Document 1) Korean Patent Laid-Open Publication No. 1999-0066108

### SUMMARY OF THE INVENTION

An object of the present invention is to provide a power inductor in which upper and lower coil electrode patterns are naturally connected to each other in a process of increasing an aspect ratio of the coil electrode patterns, such that interlayer connection of the coil electrode patterns is made without separate via electrodes while increasing the aspect ratio of the coil electrode patterns, and a manufacturing method thereof.

According to an exemplary embodiment of the present invention, there is provided a power inductor having an interlayer connection structure between upper and lower coil electrode patterns disposed on both surfaces of an insulating layer so as to face each other, the power inductor including: an opening part penetrating through the insulating layer; the upper coil electrode pattern formed on an upper surface of the insulating layer and having a form in which it is wound around the opening part; the lower coil electrode pattern formed on a lower surface of the insulating layer and having a form in which it is wound around the opening part; and metal layers plated on a surface of the innermost pattern of the upper coil electrode pattern and a surface of the innermost pattern of the lower coil electrode pattern, wherein the metal layer plated on the surface of the innermost pattern of the upper coil electrode pattern and the metal layer plated on the surface of the innermost pattern of the lower coil electrode pattern are extended to an inner wall of the opening part to thereby be connected to each other.

The metal layer plated on the surface of the innermost pattern of the upper coil electrode pattern and the metal layer plated on the surface of the innermost pattern of the lower coil electrode pattern may be formed integrally with each other.

The innermost patterns may be formed at positions spaced apart from the inner wall of the opening part by a predetermined distance so that the metal layers plated on the surfaces of the innermost patterns are extended to the inner wall of the opening part.

The power inductor may further include metal layers plated on surfaces of patterns other than the innermost patterns.

The metal layers plated on the surfaces of the innermost patterns and the metal layers plated on the surfaces of the patterns other than the innermost patterns may be simultaneously plated by electroplating using the previously formed upper and lower coil electrode patterns as lead-in wires.

The metal layers plated on the surfaces of the innermost patterns may be formed by an isotropic plating process, and the metal layers plated on the surfaces of the patterns other than the innermost patterns may be formed by an anisotropic plating process.

According to another exemplary embodiment of the present invention, there is provided a manufacturing method of a power inductor, including: plating upper and lower coil electrode patterns on upper and lower surfaces of an insulating layer, respectively; processing an opening part at a central portion of the upper and lower coil electrode patterns, the opening part penetrating through the insulating layer; and plating metal layers on surfaces of the upper and lower coil electrode patterns, respectively, wherein in the plating of the metal layers, the metal layer plated on a surface of the innermost pattern of the upper coil electrode pattern and the metal layer plated on a surface of the innermost pattern of the lower coil electrode pattern are extended to an inner wall of the opening part to thereby be connected to each other.

The plating of the metal layers may be performed by electroplating using the upper and lower coil electrode patterns as lead-in wires.

At the time of the electroplating, isotropic plating may be performed on the surfaces of the innermost patterns, and anisotropic plating may be performed on surfaces of patterns other than the innermost patterns.

In the plating of the upper and lower coil electrode patterns, any one of a subtractive method, an additive method, a semi-additive method, and a modified semi-additive method may be used.

The above-mentioned aspects, features, and advantages and other aspects, features, and advantages will become obvious from the following drawings, claims, and detailed description of the present invention.

### BRIEF DESCRIPTION OF THE DRAWINGS

FIG. 1 is a cross-sectional view of a general thin film type power inductor;

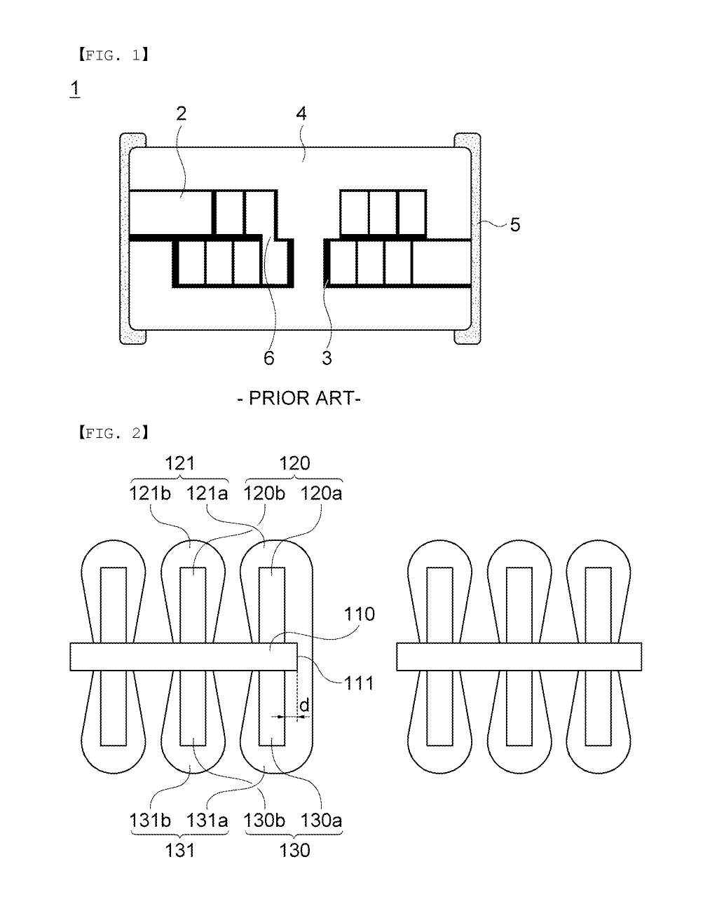

FIG. 2 is a cross-sectional view of a power inductor device according to an exemplary embodiment of the present invention for describing an interlayer connection structure of the power inductor device; and

FIGS. 3 to 5 are views sequentially showing a manufacturing method of a power inductor according to an exemplary embodiment of the present invention.

### DESCRIPTION OF THE PREFERRED EMBODIMENTS

Various advantages and features of the present invention and methods accomplishing thereof will become apparent from the following description of exemplary embodiments with reference to the accompanying drawings. However, the present invention may be modified in many different forms and it should not be limited to exemplary embodiments set forth herein. These exemplary embodiments may be provided so that this disclosure will be thorough and complete, and will fully convey the scope of the invention to those skilled in the art.

Terms used in the present specification are for explaining exemplary embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

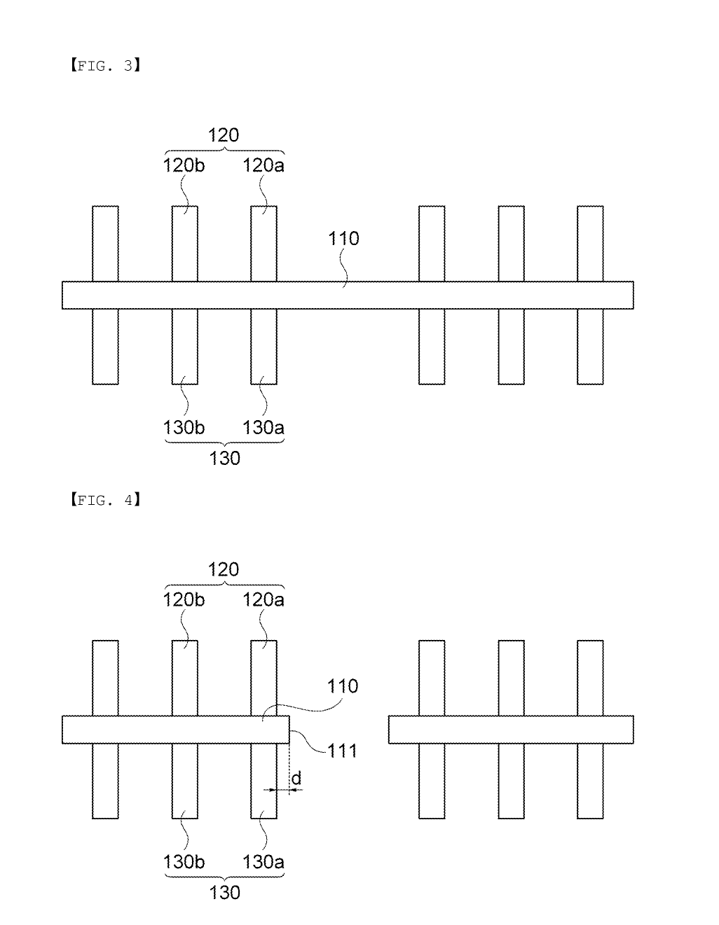

FIG. 2 is a cross-sectional view of a power inductor device according to an exemplary embodiment of the present invention for describing an interlayer connection structure of the power inductor device. Additionally, components shown in the accompanying drawings are not necessarily shown to scale. For example, sizes of some components shown in the accompanying drawings may be exaggerated as compared with other components in order to assist in the understanding of the exemplary embodiments of the present invention.

Referring to FIG. 2, the power inductor device according to the exemplary embodiment of the present invention is basically configured to include an insulating layer 110 and upper and lower coil electrode patterns 120 and 130 formed on upper and lower surfaces of the insulating layer 110, respectively.

The insulating layer 110, which is a unit supporting the upper and lower coil electrode patterns 120 and 130 and insulating the upper and lower coil electrode patterns 120 and 130 from each other, may be made of various materials that have low electric conductivity and hardly pass through current, such as prepreg, polyimide, polyethyeleneterepthalate (PET), cyanide ester, Ajinomoto build up film (ABF), epoxy, or the like.

The upper and lower coil electrode patterns 120 and 130, which are electrodes plated in a coil shape on the surfaces of the insulating layer 110, may be disposed on both surfaces of the insulating layer 110 so as to face each other and be made of a metal material having excellent conductivity, such as copper (Cu), silver (Ag), gold (Au), aluminum (Al), iron (Fe), titanium (Ti), tin (Sn), nickel (Ni), molybdenum (Mo), or the like.

The insulating layer 110 includes an opening part 111 formed at a predetermined position thereof. Since the power inductor device according to the exemplary embodiment of the present invention does not have a structure according to the related art in which the upper and lower coil electrode patterns are connected to each other by the via electrode, the opening part 111 is not a via hole for forming the via electrode. Therefore, the opening part 111 needs not to be formed at a position of the insulating layer 110 matched to distal ends of the upper and lower coil electrode patterns 120 and 130.

That is, the opening part 111, which is a space in which a metal-polymer composite (not shown) enclosing the insulating 110 and the upper and lower coil electrode patterns 120 and 130 therein is filled and formed, may be formed at a central portion of the insulating layer 110 so that the upper and lower coil electrode patterns 120 and 130 are wound based on the opening part 111.

Therefore, it may be understood that a term ‘the innermost pattern 120a of an upper coil electrode pattern 120 mentioned below indicates a pattern formed at a position of the upper coil electrode pattern 120 that is the closest to the opening part 111. Likewise, it may be understood that a term ‘the innermost pattern 130a of a lower coil electrode pattern 130 mentioned below means a pattern formed at a position of the lower coil electrode pattern 130 that is the closest to the opening part 111.

The innermost patterns 120a and 130a include metal layers 121a and 131a plated on surfaces thereof, respectively, and the metal layer 121a plated on the surface of the innermost pattern 120a and the metal layer 131a plated on the surface of the innermost pattern 130a are extended to an inner wall of the opening part 111 to thereby be connected to each other. Therefore, the metal layer 121a and the metal layer 131a may be formed integrally with each other. As a result, the upper coil electrode pattern 120 and the lower coil electrode pattern 130 are electrically connected to each other.

That is, the power inductor device according to the exemplary embodiment of the present invention does not have a structure according to the related art in which the upper and lower coil electrode patterns are connected to each other by the via electrode, but has a structure in which interlayer connection is made using the metal layers 121a and 131a plated on the innermost patterns 130a and 130a, respectively, that are closest to the opening part 111.

Here, the metal layers may be plated on surfaces of other patterns 120b and 130b as well as the innermost patterns 120a and 130a, and the metal layers 121a and 131a plated on the surfaces of the innermost patterns 120a and 130a, respectively, and the metal layers 121b and 131b plated on the surfaces of the patterns 120b and 130b, respectively, may be electro-plated using the previously formed upper and lower coil electrode patterns 120 and 130 as lead-in wires and be simultaneously plated collectively on the entire upper and lower coil electrode patterns 120 and 130.

Here, at the time of electro-plating, a structure hindering the plating from being performed is not present in a direction toward an inner portion of the innermost patterns 120a and 130a, that is, in a direction in which the opening part 111 is positioned, such that the isotropic plating is performed. That is, the plating is performed in a width direction as well as a height direction. Therefore, the metal layer 121a plated on the surface of the innermost pattern 120a and the metal layer 131a plated on the surface of the inmost pattern 130a are connected to the inner wall of the opening part 111 to thereby be connected to each other.

In addition, on the patterns 120b and 130b other than the innermost patterns 120a and 130a, anisotropic plating in which the plating in the width direction is hindered due to pattern structures of both sides is performed. As a result, the metal layers 121b and 131b plated on the surfaces of the patterns 120b and 130b, respectively, are mainly plated in the height direction, such that an aspect ratio (plating height/plating width) of the pattern is increased to a predetermined value or more, thereby making it possible to improve direct current (DC) resistance characteristics (Rdc) of the power inductor device.

As described above, the power inductor device according to the exemplary embodiment of the present invention has a structure in which the upper and lower coil electrode patterns are connected to each other by the metal layers plated on the surfaces of the innermost patterns of the coil electrode patterns in a process for increasing the aspect ratio of the coil electrode patterns, that is, an electroplating process using the previously formed coil electrode patterns as lead-in wires.

Meanwhile, the innermost patterns 120a and 130a should be formed at positions spaced apart from the inner wall of the opening part 111 by a predetermined distance so that the metal layers 121a and 131a plated on the surfaces of the innermost patterns 120a and 130a, respectively, may be extended to the inner wall of the opening part 111.

When a distance d between the innermost patterns 120a and 130a and the inner wall of the opening part 111 becomes a threshold value or more, the metal layers 121a and 131a plated on the surfaces of the innermost patterns 120a and 130a, respectively, do not arrive at the inner wall of the opening part 111, such that they are not extended to the inner wall of the opening part 111 or a short-circuit phenomenon between the patterns may occur due to excessive plating even though the metal layers 121a and 131a are extended to the inner wall of the opening part 111.

Therefore, it is most preferable that side surfaces of the innermost patterns 120a and 130a and an inner wall surface of the opening part 111 are formed to coincide with each other so that there is no distance between the innermost patterns 120a and 130a and the inner wall of the opening part 111. However, since it is difficult to manufacture this structure in view of a process, and there is a risk that the patterns will collapse, it is preferable that the distance d between the innermost patterns 120a and 130a and the inner wall of the opening part 111 is statistically determined through various experiments in consideration of a distance between the patterns, a plating amount of metal layers 121 and 131, and the like.

Hereinafter, a manufacturing method of a power inductor according to an exemplary embodiment of the present invention will be described.

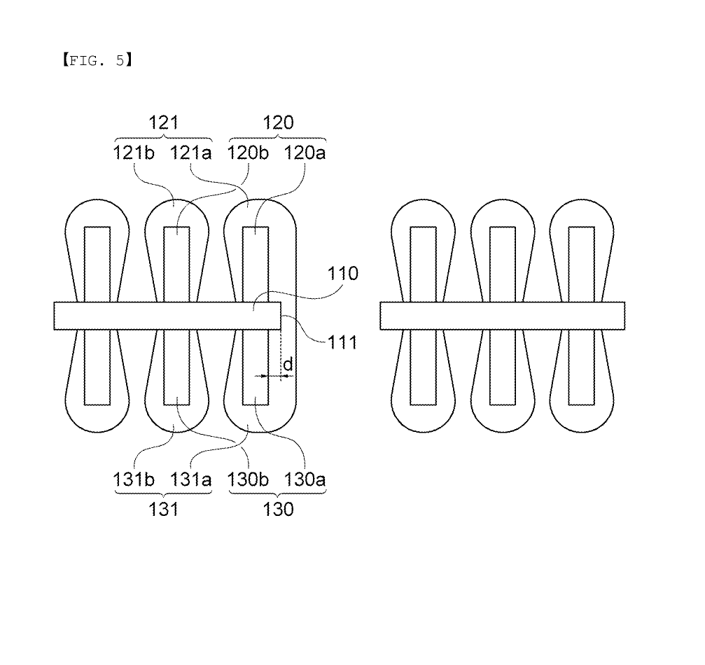

FIGS. 3 to 5 are views sequentially showing a manufacturing method of a power inductor according to an exemplary embodiment of the present invention. First, as shown in FIG. 3, an operation of plating the upper and lower coil electrode patterns 120 and 130 on the upper and lower surfaces of the insulating layer 110 is performed.

In the plating of the upper and lower coil electrode patterns 120 and 130, any one of a subtractive method, an additive method, a semi-additive method, and a modified semi-additive method may be used. Therefore, although not shown in the accompanying drawings, a seed layer for performing pre-processing such as electroplating may be present under the upper and lower coil electrode patterns 120 and 130 according to a plating method.

Next, as shown in FIG. 4, an operation of processing the opening part 111 at a central portion of the upper and lower coil electrode patterns 120 and 130 is performed, the opening part 110 penetrating through the insulating layer 110.

The opening part 111 may be formed using a laser. The laser may be a CO2 laser, an excimer laser, a YAG laser, or the like, but is not particularly limited thereto. In addition, after the opening part 111 is formed, desmear processing for removing a smear generated due to irradiation of the laser may also be performed.

At the time of processing the opening part 111, it is important to process the opening part 111 so that the innermost patterns 120a and 130a of the upper and lower coil electrode patterns 120 and 130 that are closest to the opening part 111 are disposed at positions spaced apart from the inner wall of the opening part 111 by a predetermined distance. The reason is that the metal layers 121a and 131a plated on the surfaces of the innermost patterns 120a and 130a, respectively, may not be extended to the inner wall of the opening part 111 in a subsequent operation when the distance d between the innermost patterns 120a and 130a and the inner wall of the opening part 111 becomes a threshold value or more.

The distance d between the innermost patterns 120a and 130a and the inner wall of the opening part 111 may be statistically determined through various experiments in consideration of a distance between the patterns, a plating amount of metal layers 121 and 131, and the like.

After the opening part 111 is processed, finally, as shown in FIG. 5, an operation of plating the metal layers 121 and 131 on the surfaces of the upper and lower coil electrode patterns 120 and 130, respectively, is performed, thereby making it possible to finally complete the power inductor device according to the exemplary embodiment of the present invention in which the upper and lower coil electrode patterns 120 and 130 are electrically connected to each other.

The metal layers 121 and 131 may be formed by performing electroplating using the upper and lower coil electrode patterns 120 and 130 as the lead-in wire. Here, at the time of electro-plating, a structure hindering the plating from being performed is not present in a direction toward an inner portion of the innermost patterns 120a and 130a, that is, in a direction in which the opening part 111 is positioned, such that the isotropic plating is performed.

As a result, the metal layer 121a plated on the surface of the innermost pattern 120a and the metal layer 131a plated on the surface of the innermost pattern 130a are extended to the inner wall of the opening part 111 to thereby be connected to each other. Therefore, the upper and lower coil electrode patterns 120 and 130 are electrically connected to each other.

In addition, the metal layers 121b and 131b each plated on the patterns 120b and 130b other than the innermost patterns 120a and 130a are hindered from performing the plating in the width direction due to pattern structures of both sides and are plated only in the height direction (that is, anisotropically plated), such that an aspect ratio (plating height/plating width) of the patterns is increased.

As described above, in the manufacturing method of a power inductor device according to the exemplary embodiment of the present invention, the upper and lower coil electrode patterns 120a and 130a are naturally connected to each other using the metal layers 121a and 131a isotropically plated on the surfaces of the innermost patterns 120a and 130a, respectively, in the process for increasing the aspect ratio of the patterns, that is, an electroplating process using the previously formed coil electrode patterns 120 and 130 as the lead-in wires. Therefore, unlike the related art, a complicated process for manufacturing a via electrode needs not to be performed, thereby making it possible to significantly improve a process yield. In addition, the aspect ratio of the patterns is increased, thereby making it possible to improve DC resistance characteristics (Rdc) of the power inductor device.

With the power inductor according to the exemplary embodiment of the present invention, since interlayer connection of the coil electrode patterns is made without separate via electrodes, a process for forming the via electrodes needs not to be performed, such that a process may be simplified. Therefore, a process cost and a process time may be decreased.

In addition, according to the exemplary embodiment of the present invention, since the interlayer connection of the coil electrode patterns is naturally made in a process of increasing an aspect ratio of the coil electrode patterns, direct current (DC) resistance characteristics (Rdc) of the power inductor device may be improved due to the increase in the aspect ratio of the coil electrode patterns.

The present invention has been described in connection with what is presently considered to be practical exemplary embodiments. Although the exemplary embodiments of the present invention have been described, the present invention may be also used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. A power inductor having an interlayer connection structure between upper and lower coil electrode patterns disposed on both surfaces of an insulating layer so as to face each other, the power inductor comprising:
an opening part penetrating through the insulating layer;
the upper coil electrode pattern formed on an upper surface of the insulating layer and having a form in which it is wound around the opening part;
the lower coil electrode pattern formed on a lower surface of the insulating layer and having a form in which it is wound around the opening part; and
metal layers plated on a surface of the innermost pattern of the upper coil electrode pattern and a surface of the innermost pattern of the lower coil electrode pattern,
wherein the metal layer plated on the surface of the innermost pattern of the upper coil electrode pattern and the metal layer plated on the surface of the innermost pattern of the lower coil electrode pattern are extended to an inner wall of the opening part to thereby be connected to each other.

2. The power inductor according to claim 1, wherein the metal layer plated on the surface of the innermost pattern of the upper coil electrode pattern and the metal layer plated on the surface of the innermost pattern of the lower coil electrode pattern are formed integrally with each other.

3. The power inductor according to claim 1, wherein the innermost patterns are formed at positions spaced apart from the inner wall of the opening part by a predetermined distance so that the metal layers plated on the surfaces of the innermost patterns are extended to the inner wall of the opening part.

4. The power inductor according to claim 1, further comprising metal layers plated on surfaces of patterns other than the innermost patterns.

5. The power inductor according to claim 4, wherein the metal layers plated on the surfaces of the innermost patterns and the metal layers plated on the surfaces of the patterns other than the innermost patterns are simultaneously plated by electroplating using the previously formed upper and lower coil electrode patterns as lead-in wires.

6. The power inductor according to claim 4, wherein the metal layers plated on the surfaces of the innermost patterns are formed by an isotropic plating process, and the metal layers plated on the surfaces of the patterns other than the innermost patterns are formed by an anisotropic plating process.

7. A manufacturing method of a power inductor, comprising:
plating upper and lower coil electrode patterns on upper and lower surfaces of an insulating layer, respectively;
processing an opening part at a central portion of the upper and lower coil electrode patterns, the opening part penetrating through the insulating layer; and
plating metal layers on surfaces of the upper and lower coil electrode patterns, respectively,
wherein in the plating of the metal layers, the metal layer plated on a surface of the innermost pattern of the upper coil electrode pattern and the metal layer plated on a surface of the innermost pattern of the lower coil electrode pattern are extended to an inner wall of the opening part to thereby be connected to each other.

8. The manufacturing method according to claim 7, wherein the plating of the metal layers is performed by electroplating using the upper and lower coil electrode patterns as lead-in wires.

9. The manufacturing method according to claim 8, wherein at the time of the electroplating, isotropic plating is performed on the surfaces of the innermost patterns, and anisotropic plating is performed on surfaces of patterns other than the innermost patterns.

10. The manufacturing method according to claim 7, wherein in the plating of the upper and lower coil electrode patterns, any one of a subtractive method, an additive method, a semi-additive method, and a modified semi-additive method is used.
